(19) United States
(12) Patent Application Publication
(10) Pub. No.: US 2026/0077926 A1
(43) Pub. Date: Mar. 19, 2026

(54) PRESSURISED CONTAINER WITH DEFORMABLE SHOULDER AND DEFORMABLE BOTTOM

(71) Applicant: SIDEL PARTICIPATIONS, Octeville-sur-Mer (FR)

(72) Inventors: Michel BOUKOBZA, OCTEVILLE- SUR-MER (FR); Arnaud DELAUNAY, OCTEVILLE-SUR-MER (FR); Mikael DERRIEN, OCTEVILLE-SUR-MER (FR)

(21) Appl. No.: 19/109,348

(22) PCT Filed: Aug. 16, 2023
(86) PCT No.: PCT/EP2023/072591

§ 371 Date: Mar. 6, 2025

(30) Foreign Application Priority Data
Sep. 7, 2022 (FR) FR2208929

(51) Int. Cl. B65D 79/00; B29C 49/48; B29L 31/00; B65D 1/02

(52) U.S. Cl. CPC B65D 79/0081; B29C 49/4802; B65D 1/0276; B65D 79/0084; B29L 2031/7158

(57) ABSTRACT

Described are containers and moulds for producing containers. The container is obtained by blow moulding or stretch blow moulding from a blank made of plastic material. The container includes a body, a shoulder extending from the shoulder, and a bottom at the lower end of said body. The shoulder is articulated between an extended position and a retracted position. The bottom is articulated to the lower end of the body between an extended position and a retracted position. When the container is filled and closed, the movement of the shoulder from the extended position into the retracted position causes the bottom to move from the retracted position into the extended position and vice-versa.

### TECHNICAL FIELD

The present invention relates to a container, and more particularly to a potentially stackable PET bottle, comprising for this purpose a bottom and a neck that are substantially complementary, so as to allow stable stacking of the containers, as well as to a mold for the production of such containers.

### PRIOR ART

It is well known to produce stackable containers. This is the case notably with U.S. Pat. No. 2,077,027 which describes a stackable container, which comprises a body and a frustoconical shoulder attached and fastened to the body by a folded edge. Stacking this type of container is naturally stable, but this stability depends largely on the (metal) material from which the container is made.

However, it is difficult to obtain such stability when the container is obtained by blow molding (or stretch blow molding) from a blank (notably a preform) made of plastics material such as polyethylene terephthalate (PET). In fact, in addition to the fact that plastics are naturally malleable, the demands of the market are pushing production toward lighter weight containers, which reduces the rigidity of said containers.

In this respect, document EP 0698557 describes such a stackable container made of plastics material, the bottom of which is shaped to be substantially complementary to the neck in order to allow stacking. To this end, the periphery of the bottom and the periphery of the shoulder of the container are provided with flat bearing surfaces, and the bottom is furthermore provided with a hollow portion for receiving the neck of a container below.

Nevertheless, the manufacture of such a container requires a substantial quantity of material for the bottom, to make the bottom sufficiently rigid, capable of conferring good mechanical strength to the whole of the container, and adequately stable when stacked. Similarly, a sufficient quantity of material is necessary to ensure good blowability of the bottom (i.e. ability to be correctly formed). On the contrary, inadvisedly lightening the container, notably the bottom thereof, is detrimental to the mechanical strength of the container and to the stability of the related stack.

In order to remedy these drawbacks, there is already a container comprising means for creating a positive pressure inside the container and, ultimately, reinforcing said container. This is the case notably with document WO2007/127337.

Said document WO2007/127337 describes a plastics container including an upper portion comprising a neck designed to receive a closure, a lower portion comprising a base and a side wall extending between the upper portion and the lower portion. The upper portion, the lower portion and the side wall define an internal volume for storing liquid content. The plastics container further includes a pressure panel located on the container and movable between an initial position and an activated position. The pressure panel is located in the initial position prior to filling the container and is moved to the activated position after filling the container. Moving the pressure panel from the initial position to the activated position reduces the internal volume of the container and creates a positive pressure inside the container, said positive pressure reinforcing the side wall.

Document EP2861499 from the applicant is also known, describing a container in which the shoulder is articulated between at least a stable deployed position and a stable retracted position in which the internal volume of the container is reduced so as to create a positive pressure inside the container.

Said document EP2861499 describes a container obtained by blow molding or stretch blow molding from a blank of plastics material which comprises a body, a shoulder extending an upper end of the body, and a neck extending the shoulder, the shoulder being articulated between two stable positions, namely a deployed position in which the shoulder projects from the body and a retracted position in which the shoulder is at least partially withdrawn into the body, the shoulder being articulated so that it can adopt, in addition to the deployed and retracted positions, an intermediate third stable position between the deployed position and the retracted position. The retracted position, which enables stacking, enables the shoulder height, and consequently the receiving volume provided in the bottom, to be reduced. Moreover, since the shoulder is moved to the retracted position after filling and capping the container, the content of said container is pressurized and increases the rigidity of the container. Thus, the stability of the stack of containers is increased while reducing the amount of material needed to form the bottom.

It can be seen that it is difficult to obtain a good compromise between the stacking stability and the lightweightness of a container made of plastics material. Furthermore, there is now increasing demand to reduce the weight of containers, not only for economic reasons related to the increasing costs of raw materials, but also for ecological reasons.

Thus, the objective of the invention is to improve the rigidity and stability of the stack of containers in which the quantity of material, and consequently the weight thereof, is as small as possible without thereby requiring additional pressurized gas, such as liquid nitrogen for example, to be added to the interior of said containers.

### DISCLOSURE OF THE INVENTION

One of the objectives of the invention is therefore to overcome these drawbacks by proposing a container and a mold of simple and inexpensive design, requiring a small quantity of material while providing good rigidity.

To this end, the invention proposes a container obtained by blow molding or stretch blow molding from a blank of plastics material, which comprises a body, a shoulder extending an upper end of said body, a neck extending the shoulder, said shoulder being articulated between at least two stable positions, namely a deployed position in which the shoulder extends level with the upper end of the body or projects from the body, and a retracted position in which the shoulder is at least partially withdrawn into the body, and a bottom at the lower end of said body, said container being noteworthy in that said bottom is articulated with the lower end of the body between at least two stable positions, namely a deployed position in which the bottom extends level with the lower end of the body or projects at least partially from the body and a retracted position in which said bottom is at least partially withdrawn into the body such that, when the container is filled and closed, moving the shoulder from the deployed position to the retracted position moves the bottom from the retracted position to the deployed position and vice versa.

Preferably, the articulations of the shoulder with the body and of the bottom with the body are designed in such a way that, when the container is filled and closed, moving the shoulder from the deployed position to the retracted position causes the bottom to move from the retracted position to the deployed position while maintaining a pressure level inside the bottle greater than 100 mbar.

According to a preferred embodiment of the invention, the shoulder comprises a peripheral section, a central section and a sub-neck section, a first articulation being defined at a join between the peripheral section and the central section and a second articulation being defined at a join between the central section and the sub-neck section.

Furthermore, the second articulation of the shoulder defined at the join between the central section and the sub-neck section is designed to remain locked in the retracted position.

Furthermore, the bottom comprises a peripheral section and a central section, a first articulation being defined at a join between the peripheral section and the central section and a second articulation being defined at a join between the peripheral section and the body.

Preferably, the central section of the bottom comprises a concave central dome in the form of a substantially spherical cap with its concavity facing the outside of the container in the absence of stress.

Said central dome is rigid or semi-rigid and non-deformable.

To this end, said central dome may include one or more stiffening members.

Preferably, said central dome includes a plurality of radial grooves extending from the center of said central dome to the first articulation of the bottom.

Said body has a substantially frustoconical shape, of which the large base corresponds to the lower end of the body and the small base corresponds to the upper end of said body.

According to a variant embodiment, the body has a square cross-section with quarter-round edges.

According to another variant embodiment, the body has a substantially cylindrical shape.

Furthermore, the body is provided with at least one deformable zone.

Advantageously, with the exception of the deformable zone or zones, the body is stiffened.

Preferably, the body has, over all or part of the height thereof, a stack of annular stiffening members.

Another object of the invention relates to a mold for manufacturing a container according to the invention by blow molding or stretch blow molding a blank of plastics material. Said mold comprises at least one mold bottom which can be mounted movably in a side wall which defines a cavity with the impression of a portion of the container, said side wall comprising two half-molds each defining a half-impression of the body of the container and mounted rotatably with respect to each other between an open position, in which the half-molds are spaced apart angularly from each other and the mold bottom is lowered relative to the half-molds to enable insertion of the blank and removal of the formed container, and a closed position, in which the half-molds are pressed against each other and enclose the mold bottom therebetween to form the cavity and define the total impression of the container to be formed, said mold being noteworthy in that the half-impressions of the side walls and/or the mold bottom are shaped to produce a container according to the invention.

### BRIEF DESCRIPTION OF THE DRAWINGS

Further advantages and features will become better apparent from the following description, given by way of nonlimiting example, of several variant embodiments of the container and of the mold for producing said container according to the invention, with reference to the attached drawings in which:

FIG. 1 is a perspective view illustrating a container according to the invention with the shoulder in a retracted position,

FIG. 2 is a side view of a container according to the invention with the shoulder in a deployed position,

FIG. 3 is an elevation view of the upper portion of the container with the shoulder in a deployed position,

FIG. 4 is an elevation view of the upper portion of the container with the shoulder in a retracted position,

FIG. 5 is an elevation view of the lower portion of the container with the bottom in a retracted position,

FIG. 6 is an elevation view of the lower portion of the container with the bottom in a deployed position,

FIG. 7 is a side view of the upper portion of the container with the shoulder in the deployed position,

FIG. 8 is a side view of the lower portion of the container with the bottom in the retracted position,

FIG. 9 is an exploded perspective view of a mold for the production of a container according to the invention.

### EMBODIMENT OF THE INVENTION

In the remainder of the description of the container according to the invention, the same numerical references are used to denote the same elements. The different views are not necessarily plotted to scale.

The figures show a container 1 obtained by blow molding, or by stretch blow molding, from a blank of plastics material not shown in the figures. Said blank is for example a preform, but may also be an intermediate container that has undergone a first transitional blowing operation.

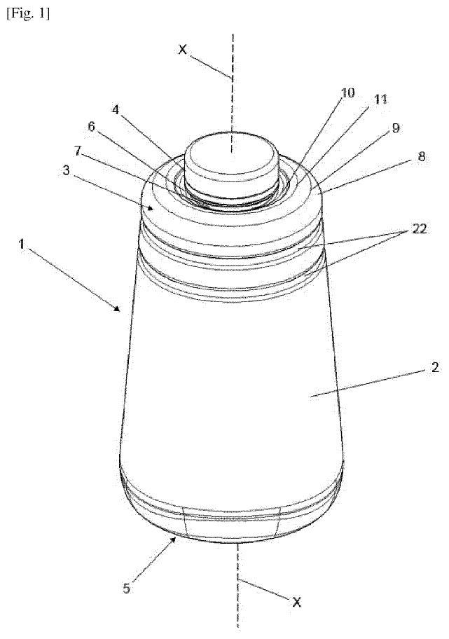

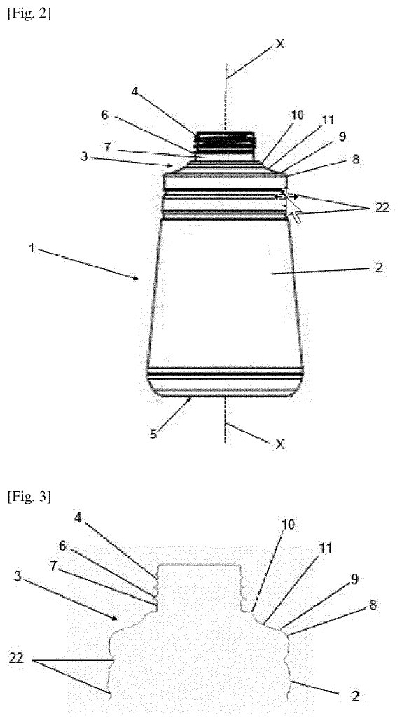

With reference to FIGS. 1 and 2, said container 1 comprises a body 2 of substantially frustoconical shape which extends along the main axis X, said main axis X being vertical, the container 1 usually being shown in a vertical position. It will be noted that the body 2 is not necessarily symmetrical in revolution about the main axis X thereof. Indeed, it could have a circular cross-section, such as cylindrical, or a square cross-section with quarter-round edges, i.e. rounded at the corners, or not, without thereby departing from the scope of the invention.

Said container 1 also comprises a shoulder 3 extending an upper end of the body 2, a neck 4 extending the shoulder 3, and a bottom 5 extending a lower end of the body 2. Said neck 4 has, in the vicinity of the join thereof with the shoulder 3, a collar 6 which is already present at the open end of the blank and which allows said blank to be suspended at various stages of manufacture of the container 1. Moreover, between the collar 6 and the shoulder 3, the container 1 has a sub-neck section 7 that is cylindrical in revolution about the main axis X, leaving a space large enough to accommodate a member for gripping the container 1, such as a clamp for example.

Said shoulder 3 comprises a peripheral section 8 in the form of a relatively narrow strip of material, i.e. a strip having a width between 0.5 mm and 25 mm, the width depending notably on the dimensions of the container 1, which extends from an outer edge and which defines an outer first articulation 9 of the shoulder 3 with respect to the body 2, at a join between the upper end of the body 2 to an inner edge concentric with the outer edge, said inner edge defining an inner second articulation 10 of a central section 11 of the shoulder 3 with respect to the peripheral section 8. The central section 11 of the shoulder 3 is substantially frustoconical and extends from the inner articulation 10 of the peripheral section 8 to the sub-neck section 7.

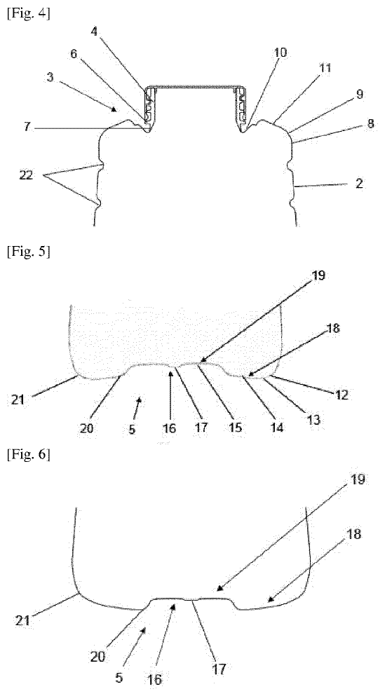

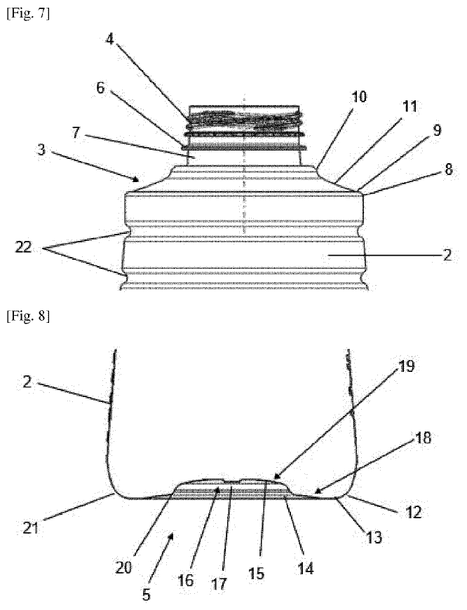

The outer articulation 9 and the inner articulation 10 enable the shoulder 3 to adopt two stable positions, namely a retracted position, shown in FIGS. 1 and 4, in which the shoulder 3 is at least partially withdrawn into the body 2, the shoulder being retracted toward the bottom 5, along the main axis X, and the peripheral section 8 and the central section 11 both being inclined, i.e. tapered upward toward the neck 4, and toward the main axis X; and a deployed position, as shown in FIGS. 2, 3 and 7, in which the shoulder 3 projects from the body 2, the peripheral section 8 and the central section 11 both being inclined, i.e. tapered upward toward the neck 4 and toward the main axis X.

According to a variant embodiment, not shown in the figures, said shoulder 3 could, in the deployed position thereof, extend level with the upper end of the body 2, i.e. extend perpendicular to the main axis X of the container 1, without thereby departing from the scope of the invention.

As shown, the deployed position (FIGS. 2, 3 and 7) is as formed, i.e. the container 1 is formed in this deployed position. The container 1 is filled and capped in this deployed position.

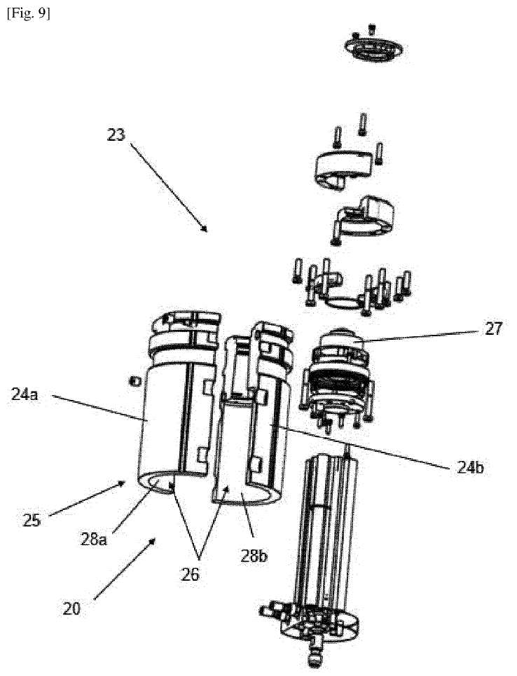

Furthermore, with reference to FIGS. 5, 6 and 8, the bottom 5 of the container 1 comprises a peripheral heel 12 in the form of an annular bead which extends the body 2 substantially axially. The peripheral heel 12 terminates in a standing plane 13, also called a seat, perpendicular to the main axis X of the container 1, said standing plane 13 defining the lower end of the container 1 and enabling the container 1 to be stood vertically on a flat surface.

Toward the inside of the container 1, the peripheral heel 12 comprises a frustoconical annular cheek 14 which extends the standing plane 13 toward the inside of the container 1, the frustoconical shape formed by the annular cheek 14 opening downward. Furthermore, the bottom 5 also comprises a concave central dome 15 in the form of a substantially spherical cap with its concavity facing the outside of the container 1 in the absence of stress, i.e. when the container 1 is empty. The central dome 15 extends from the peripheral heel 12, extending the annular cheek 14, as far as a central zone 16 of the bottom 5 forming a stud projecting toward the outside of the container 1, with a generally amorphous pellet 17 at the center thereof corresponding to the injection zone of the constituent material of the preform used to make the container 1, which can be used for centering during blow molding of the container 1.

Furthermore, said bottom 5 comprises a peripheral section 18 extending substantially from the peripheral heel 12 to the central dome 15 and a central section 19 which corresponds substantially to the central dome 15, a first articulation 20 being defined at a join between the peripheral section 18 and the central section 19 and a second articulation 21 being defined at a join between the peripheral section 18 and the body 2 of the container 1. Unlike the inner articulation 10 of the shoulder 3, which is designed to remain locked in the retracted position, the first articulation 20 and the second articulation 21 are not designed to remain locked.

The shoulder 3 is moved from the deployed position, in which the container is filled and then capped with a closure, to the retracted position by turning the central section 11 about the inner articulation 10 of the shoulder 3 by exerting downward pressure on the closure closing the neck 4. The orientation of the peripheral section 8 remains substantially unchanged and the neck 4 is driven downward in translation along the main axis X of the piston, which is enabled by the pivoting of the central section 11 relative to the neck 4 about the outer articulation 9. Moreover, in this particular embodiment, when the shoulder 3 is in the retracted position, the height of the container 1 is less than the height of said container 1 when the shoulder 3 is in the deployed position, despite the deformation of the bottom 5. In this regard, it will be noted that the central dome 15 of the bottom 5 is rigid or semi-rigid, and not deformable. Preferably, said central dome 15 includes one or more stiffening members, not shown in the figures, such as radial grooves extending substantially from the pellet 17 to the first articulation 20.

Once the container 1 has been filled, the retraction of the shoulder 3 causes the content of the container 1 to be pressurized and moves the bottom 5 from the retracted position to the deployed position, the movement of the bottom 5 from the retracted position to the deployed position partially compensating for said pressurization. It will be noted that the articulations of the shoulder with the body 2 and of the bottom 5 with the body 2 are designed in such a way that, when the container 1 is filled and closed, moving the shoulder 3 from the deployed position to the retracted position causes the bottom 5 to move from the retracted position to the deployed position while maintaining a pressure level inside the bottle greater than 100 mbar. Thus, the container 1 is slightly deformed with an internal pressure which enables said container to be stiffened, thereby enabling the thickness of the walls of the container to be reduced and reducing the amount of material used for manufacture, notably the material required for the bottom 5.

According to a variant embodiment, not shown in the figures, the bottom 5 could, in the deployed position thereof, extend level with the lower end of the body 2 such that the annular cheek 14 then forms, in this deployed position, the seat of the container 1.

Incidentally, the upper portion of the body 2 is provided, just below the shoulder 3, with two annular stiffening members 22 to stiffen said body 2.

It goes without saying that the body 2 may comprise several annular stiffening members over all or part of the height thereof, depending notably on the shape and dimensions of the body 2 of the container, without thereby departing from the scope of the invention.

According to a variant embodiment, not shown in the figures, the body 2 could be provided with at least one deformable zone, such as a deformable panel, not shown in the figures, without thereby departing from the scope of the invention. Furthermore, with the exception of the deformable zone or zones, the body is stiffened. In this regard, the body 2 may have, over all or part of the height thereof, a stack of annular stiffening members.

With reference to FIG. 9, a molding unit 23 according to the invention is described for forming, from a blank, usually a preform, a container, such as a bottle or a can, according to the invention.

Said molding unit 23, with reference to FIG. 9, comprises a mold 24 provided with a side wall 25 which defines a cavity 26 with the impression of a portion of the container. Said mold 24 further comprises a bottom 27 with the impression of the bottom of the container, said mold 24 being made of metal, for example steel or aluminum (this term also covering aluminum alloys). The cavity 26, and ultimately the container 1, extends along a main axis X which defines a vertical direction. Any plane perpendicular to the main axis X is said to be horizontal. According to an embodiment illustrated in the drawings, the side wall 25 comprises two half-molds 24A, 24B each defining a half-impression 28A, 28B of the body of the container and mounted rotatably with respect to each other about a common axis formed by a hinge, not shown in the figures, between an open position, in which the half-molds 24A, 24B are spaced apart angularly from each other and the mold bottom 27 is lowered relative to the half-molds 24A, 24B to enable insertion of the blank and removal of the formed container, and a closed position, in which the half-molds 24A, 24B are pressed against each other and enclose the mold bottom 27 therebetween to form the cavity 26 and define the impression of the container to be formed. Thus, said mold bottom 27 can be mounted movably in the mold 24 comprising two walls which are movable relative to each other and intended to form the body of the container, said movable mold bottom 27 pushing the plastics material constituting the container toward the opening thereof. The half-impressions 28A, 28B of the side walls 25 and/or the mold bottom 27 are shaped to produce a container 1 according to the invention as described above.

Finally, it is quite obvious that the examples which have just been given are only particular illustrations in no way limiting the fields of application of the invention.

1. A container obtained by blow molding or stretch blow molding from a blank of plastics material, the container comprising:
a body comprising an upper end and a lower end;
a shoulder extending from the upper end of said body;
a neck extending the shoulder,
wherein the shoulder is articulated between at least two stable positions, wherein a first stable position is a deployed shoulder position in which the shoulder projects from the body, and wherein the second stable position is a retracted shoulder position in which the shoulder extends level with the upper end of the body or is at least partially withdrawn into the body; and
a bottom at the lower end of said body,
wherein the bottom is articulated with the lower end of the body between at least two additional stable positions, wherein the first additional stable position is a deployed bottom position in which the bottom extends level with the lower end of the body or projects at least partially from the body, and wherein the second additional position is a retracted bottom position in which said bottom is at least partially withdrawn into the body such that, when the container is filled and closed, moving the shoulder from the deployed position to the retracted position moves the bottom from the retracted position to the deployed position and vice versa.

2. The container as claimed in claim 1, wherein the articulation of the shoulder with the body and the articulation of the bottom with the body are are configured to move the shoulder from the deployed shoulder position to the retracted shoulder position when the container is filled and closed, thereby causing the bottom to move from the retracted bottom position to the deployed bottom position while maintaining a pressure level inside the container greater than 100 mbar.

3. The container as claimed in claim 1, wherein the shoulder comprises a peripheral section, a central section and a sub-neck section,
wherein an outer first articulation is defined at a join between the peripheral section and the central section and an inner second articulation is defined at a join between the central section and the sub-neck section.

4. The container as claimed in claim 3, wherein the inner second articulation of the shoulder is configured to remain locked in the retracted position.

5. The container as claimed in claim 1, wherein the bottom comprises a peripheral section and a central section, a first articulation being defined at a join between the peripheral section and the central section and a second articulation being defined at a join between the peripheral section and the body.

6. The container as claimed in claim 5, wherein the central section of the bottom comprises a concave central dome comprising a substantially spherical cap shape, wherein a concavity of the central dome faces the outside of the container in the absence of stress.

7. The container as claimed in claim 6, wherein the central dome is rigid or semi-rigid.

8. The container as claimed in claim 7, wherein the central dome includes one or more stiffening members.

9. The container as claimed in claim 8, wherein the central dome includes a plurality of radial grooves extending from a center of said central dome to the first articulation of the bottom.

10. The container as claimed in claim 1, wherein the body has a substantially frustoconical shape, of which a large base corresponds to the lower end of the body and the small base corresponds to the upper end of the body.

11. The container as claimed in claim 1, wherein the body has a square cross-section with quarter-round edges.

12. The container as claimed in claim 1, wherein the body has a substantially circular cross-section.

13. The container as claimed in claim 1, wherein the body is comprises at least one deformable zone.

14. The container as claimed in claim 13, wherein with the exception of the at least one deformable zone, the body is stiffened.

15. The container as claimed in claim 14, wherein the body comprises a stack of annular stiffening members over all or part of a height of the body.

16. A mold for manufacturing a container according to claim 1, comprising:
at least one mold bottom movably mounted in a side wall, wherein the side wall defines a cavity with an impression of a portion of the container, said side wall comprising two half-molds each defining a half-impression of a body of the container and mounted rotatably with respect to each other between an open position,
wherein the half-molds are spaced apart angularly from each other and the mold bottom is lowered relative to the half-molds to enable insertion of the blank and removal of the formed container, and
a closed position, wherein the half-molds are pressed against each other and enclose the mold bottom therebetween to form the cavity and define the total impression of the container to be formed, wherein the half-impressions of the side walls, the mold bottom, or both are shaped to produce the container as claimed in claim 1.
